(19) United States
(12) Patent Application Publication
(10) Pub. No.: US 2011/0181391 A1
(43) Pub. Date: Jul. 28, 2011

(54) TRACKING DEVICE AND A TRACKING METHOD OF A SHIPPING CONTAINER TRUCK

(76) Inventor: Charles CHU, Banciao City (TW)

(21) Appl. No.: 12/693,935

(22) Filed: Jan. 26, 2010

(51) Int. Cl. G08B 5/22; H04B 7/216

(52) U.S. Cl. 340/8.1; 370/342

(57) ABSTRACT

The present invention discloses a tracking device and a tracking method of a shipping container truck. A tracker and an identifier are installed respectively on a truck tractor and a shipping container. After the truck tractor has been connected with the shipping container, information will be connected between the tracker and the identifier, and information related to the truck tractor and the shipping container will be further transmitted to a monitoring center through a GPS module inside the tracker, allowing the monitoring center to effectively monitor in real time the truck tractor and the shipping container.

### BACKGROUND OF THE INVENTION

a) Field of the Invention

The present invention relates to a tracking device of a shipping container truck, and more particularly to a tracking device and a tracking method of a shipping container truck, which can track and fetch location information of the shipping container truck simultaneously.

b) Description of the Prior Art

In general, after receiving a dispatch order of a shipping container truck, a user will conduct a loading process of the shipping container truck and transport the shipping container truck to an assigned place after accomplishing the loading. In the aforementioned conventional process, a monitoring center can only rely on messages of the dispatch order, such as a dispatch slip or other dispatch information, to acquire information of the shipping container that is loaded onto the shipping container truck, a departure time and a destination. However, after the shipping container truck has departed, the monitoring center will not be able to effectively take control of a current location of the shipping container truck, causing breach and inconvenience in monitoring. Moreover, to cope and solve the aforementioned issues, a logistics industry will install a GPS (Global Positioning System) positioning device (i.e., a satellite positioning device) in a truck tractor, allowing the monitoring center to take control of the current location of the shipping container truck in real time through the GPS positioning device. Nevertheless, by using this tracking method, the user can only know the current location of the truck tractor, and cannot be further aware of the loading information and the location of the shipping container, such as a driving position, a speed, a direction and the information of the shipping container that is loaded, which also prohibits the monitoring center from effectively taking control of a real condition of the shipping container truck after the shipping container truck has left a loading area.

### SUMMARY OF THE INVENTION

Accordingly, the primary object of the present invention is to provide a tracking device and a tracking method of a shipping container truck, by which driving information of the shipping container truck and information of the shipping container which is loaded can be taken control of in real time.

To achieve the aforementioned object, in the present invention, an interior of a truck tractor is installed with a tracker and an interior of the shipping container is assembled with an identifier. After a dispatch order has been received and the shipping container truck has been connected with a designated shipping container, a data connection is accomplished between the tracker and the identifier, and a location of the shipping container truck can be traced effectively through a GPS module inside the tracker. Furthermore, a wireless communication transmission module inside the tracker can be used to transmit wirelessly the driving information and the information related to the shipping container to a monitoring center, allowing the monitoring center to effectively monitor the shipping container truck and the information related to the shipping container, based upon the information received.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a structural schematic view of the present invention.

FIG. 2 shows an assembly drawing of the present invention.

FIG. 3 shows a schematic view of implementation steps of the present invention.

FIG. 4 shows a schematic view of a first preferred embodiment of the present invention.

FIG. 5 shows a schematic view of a second preferred embodiment of the present invention.

### DETAILED DESCRIPTION OF THE PREFERRED EMBODIMENTS

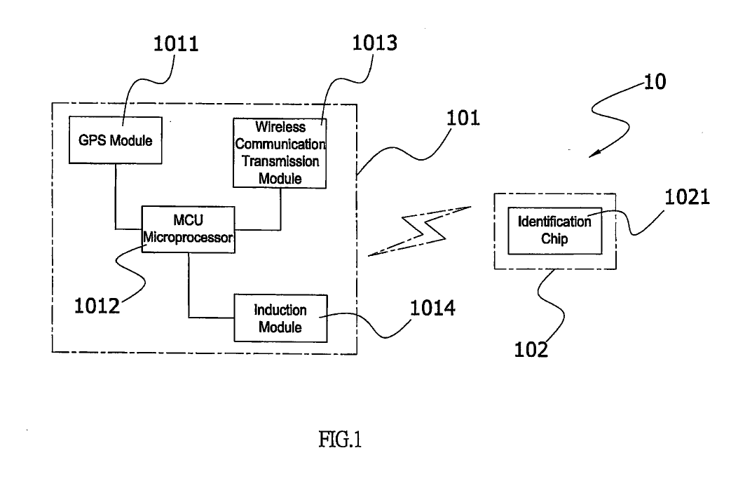

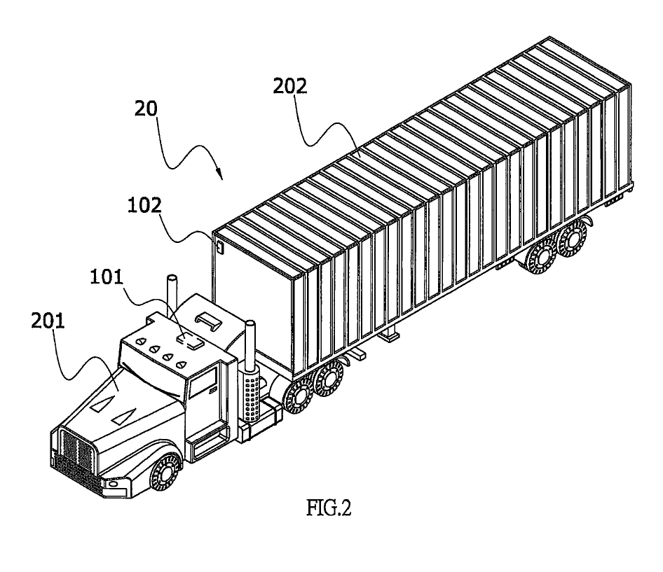

Referring to FIG. 1, it shows a structural schematic view of the present invention. As shown in the drawing, a tracking device 10 of a shipping container truck comprises primarily a tracker 101 and an identifier 102, wherein an interior of the tracker 101 is assembled with a GPS module 1011, an MCU (Microcontroller Unit) microprocessor 1012, a wireless communication transmission module 1013 and an induction module 1014. The GPS module 1011 can utilize a satellite positioning technology to store a current location, a speed and a direction of a truck tractor as electronic positioning information; whereas, the GPS module 1011 disclosed by the present invention can also apply an A-GPS (Assisted Global Positioning System) or a GPSone (combination of A-GPS and CDMA (Code Division Multiple Access) triangulation) to assure that the shipping container truck can be effectively positioned. The MCU microprocessor 1012 connects information with the GPS module 1011 to convert the electronic positioning information, which is produced by positioning with the GPS module 1011, into the electronic positioning data which can be transmitted wirelessly, after processing. The wireless communication transmission module 1013 connects information with the MCU microprocessor 1012 to receive the processed electronic positioning data from the MCU microprocessor 1012 and further transmit the received electronic positioning data to a monitoring center for monitoring and accessing, using a wireless communication transmission method, such as RF (Radio Frequency), GSM (Global System for Mobile Communications), GPRS (General Packet Radio Service), CDMA, WiMAX (Worldwide Interoperability for Microwave Access) or STSC (Satellite to Satellite Communication). The induction module 1014 connects information with the MCU microprocessor 1012, induces and fetches electronic information of the shipping container inside the identifier 102 through a wireless induction method, such as an RFID (Radio Frequency Identification) or wireless Bluetooth technology, as well as transmits the fetched electronic information of the shipping container to the MCU microprocessor 1012 for processing and converting into the electronic data of the shipping container, which is, together with the electronic positioning data, transmitted to the monitoring center through the wireless communication transmission module 1013. On the other hand, an interior of the aforementioned identifier 102 is provided with an identification chip 1021 which is pre-loaded with information related to the shipping container, such as a tag number of the shipping container, goods loaded in the shipping container and size and weight of the shipping container. Referring to FIG. 2, it shows an assembly drawing of the present invention. As shown in the drawing, a shipping container truck 20 is composed of a truck tractor 201 and a shipping container 202, wherein the tracker 101 is assembled in the truck tractor 201 and the identifier 102 is installed at a proper position of the shipping container 202, such as an interior of the shipping container, a tail light or warning light at an exterior of the shipping container. In addition, after the truck tractor 201 has been connected with the shipping container 202, the induction module 1014 (as shown in FIG. 1) inside the tracker 101 can further induce the identification chip 1021 (as shown in FIG. 1) inside the identifier 102 and accomplish the connection of information. Moreover, according to the aforementioned method, the electronic positioning data and the electronic data of the shipping container can be transmitted through the wireless communication transmission module 1013 (as shown in FIG. 1) to the monitoring center to effectively monitor the information related to the shipping container truck.

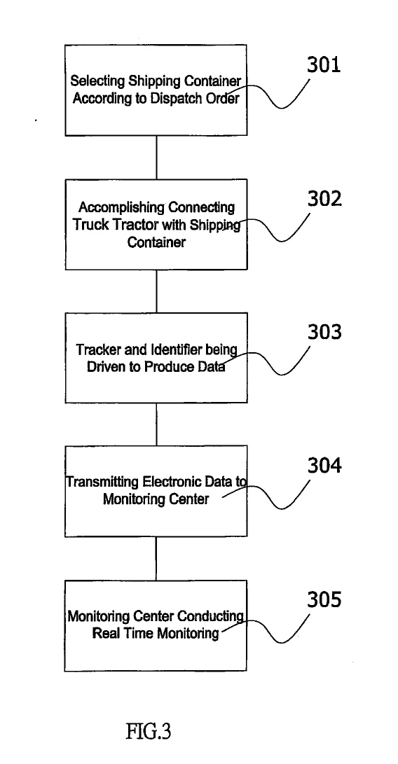

Referring to FIG. 3, it shows a schematic view of implementation steps of a tracking method of the present invention. In collaboration with FIG. 1 and FIG. 2, the implementation steps of the present invention include:

(1) First step 301 (selecting a shipping container according to a dispatch order)—the truck tractor 201 starting for to a place where the shipping containers are stored to carry a designated shipping container, according to the dispatch order;

(2) Second step 302 (accomplishing connecting the truck tractor with the shipping container)—the truck tractor 201 being connected with the designated shipping container 202 and after accomplishing the connection, the tracker 101 being driven by a power source to operate, with the power being supplied by an internal power source (such as a battery installed in the tracker 101) or an external power source (such as power supplied by the truck tractor 201);

(3) Third step 303 (the tracker and the identifier being driven to produce data)—according to the second step 302, when the tracker 101 is driven, the internal GPS module 1011 thereof immediately accomplishing satellite positioning and the induction module 1014 inducing and fetching the information of the identification chip 1021 inside the identifier 102, with the positioning data and the electronic data of the shipping container being produced by processing of the MCU microprocessor 1012;

(4) Fourth step 304 (transmitting the electronic data to the monitoring center)—according to the third step 303, the positioning data and the electronic data of the shipping container being transmitted to the remote monitoring center through the wireless communication transmission module 1013, to accomplish the transmission of the data related to the shipping container truck;

(5) Fifth step 305 (the monitoring center conducting real time monitoring)—according to the fourth step 304, after the monitoring center has received the electronic data related to the shipping container truck 20, a current location of the shipping container truck 20 and the data of the shipping container 202 that is connected being known and the monitoring center determining whether the shipping container truck 20 is connected with the shipping container 202 to effectively monitor a logistics condition of the shipping container truck 20, based upon that whether the electronic data of the shipping container is received.

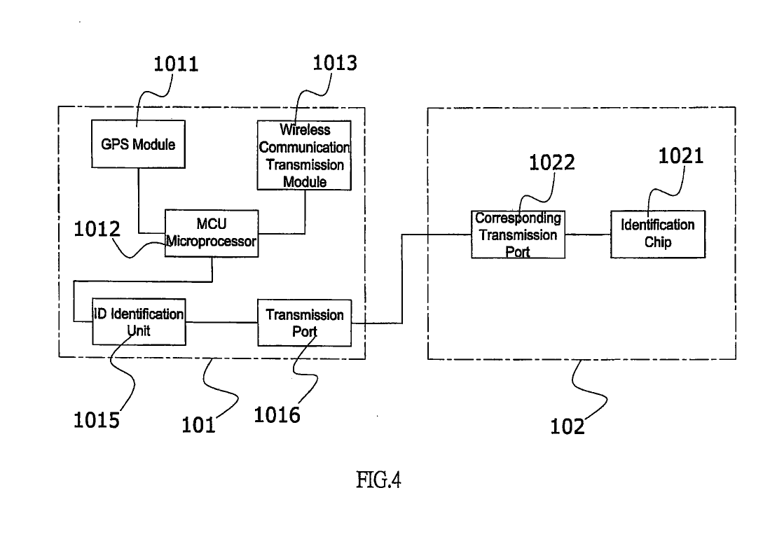

Referring to FIG. 4, it shows a schematic view of a first preferred embodiment of the present invention. In collaboration with FIG. 2, the present invention can further utilize a wired transmission method to enable the tracker 101 to fetch the data of the identifier 102. As shown in FIG. 4, the MCU microprocessor 1012 of the tracker 101 connects information with an ID identification unit 1015 which is electrically connected with a transmission port 1016; whereas, the identification chip 1021 of the identifier 102 connects information with a corresponding transmission port 1022. Moreover, when the shipping container 202 is connected to the truck tractor 201, the corresponding transmission port 1022 of the identifier 102 will accomplish the data connection with the transmission port 1016 of the truck tractor 201, allowing the transmission port 1016 of the tracker 101 to accomplish the data connection with the corresponding transmission port 1022 of the identifier 102 and accomplishing the data fetching and identification of the identifier 102 by the ID identification unit 1015, so as to facilitate the subsequent data transmission step.

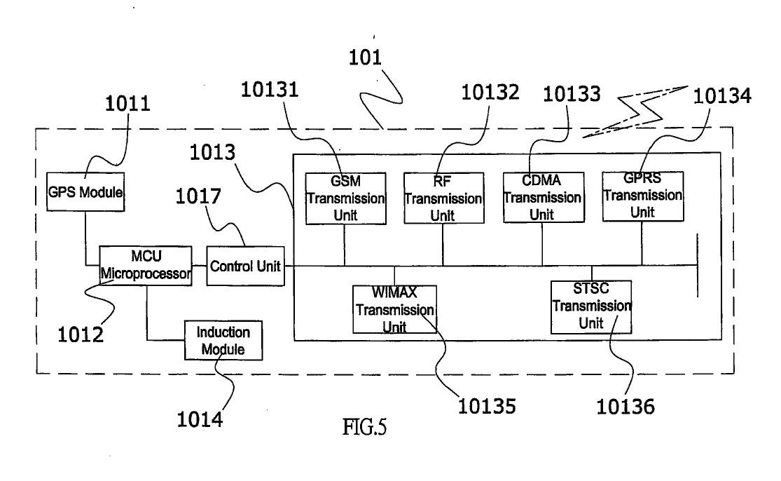

Referring to FIG. 5, it shows a schematic view of a second preferred embodiment of the present invention. As shown in the drawing, between the MCU microprocessor 1012 and the wireless communication transmission module 1013 of the tracker 101, a control unit 1017 is electrically connected, and an interior of the wireless communication transmission module 1013 can be constituted by a GSM transmission unit 10131, an RF transmission unit 10132, a CDMA transmission unit 10133, a GPRS transmission unit 10134, a WiMAX transmission unit 10135 or an STSC transmission unit 10136. When the electronic data is to be transmitted, the present invention can utilize in advance the control unit 1017 to set up a manual or automatic wireless transmission mode, wherein the manual wireless transmission mode pre-configures one kind of transmission units as a default wireless data transmission method for the tracker 101, such as manually configuring the GSM transmission unit 10131 as the default wireless transmission method. Therefore, when the tracker 101 is transmitting the electronic data, the GSM transmission unit 10131 will always be used first for the transmission of the electronic data. On the other hand, the automatic wireless transmission mode utilizes each transmission unit inside the wireless communication transmission module 1013 to conduct the electronic data transmission; for example, when the electronic data is transmitted by the GSM transmission unit 10131, if a transmission signal is bad or cannot be transmitted, then the wireless communication transmission module 1013 can automatically switch to the RF transmission unit 10132 to send out the electronic data and if the RF transmission unit 10132 is unable to transmit the electronic data, then other transmission unit will be switched to automatically, thereby effectively maintaining a good wireless transmission frequency of the tracker 101.

Concluding the above, the present invention can utilize the GPS module to accomplish the positioning of the truck tractor and when the shipping container is connected with the truck tractor, the present invention can utilize the induction module to fetch the data of the shipping container, followed by further processing the data through the MCU microprocessor to transmit the related electronic data to the monitoring center using the wireless communication transmission module, such that the monitoring center can effectively monitor the shipping container truck and the information of the shipping container that is connected to the shipping container truck. Accordingly, after implementing, the present invention can surely achieve the object of providing a tracking device and a tracking method by which the driving information of the shipping container truck and the information of the carried shipping container can be taken control of in real time.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claim is:

1. A tracking device of a shipping container truck, being used to transmit a data and a location of the shipping container truck to a monitoring center, comprising:
a tracker which is assembled in a truck tractor to transmit a driving data and a location of the truck tractor to the monitoring center; and
an identifier, which is assembled in the shipping container of the shipping container truck and an interior of which is assembled with an identification chip, with the identification chip being pre-stored with a data related to that shipping container and being inducted by the tracker to further fetch the related data.

2. The tracking device of a shipping container truck, according to claim 1, wherein the tracker is constituted by at least a GPS (Global Positioning System) module, an MCU (Microcontroller Unit) microprocessor, a wireless communication transmission module and an induction module.

3. The tracking device of a shipping container truck, according to claim 2, wherein the GPS module is an A-GPS (Assisted Global Positioning System) positioning system.

4. The tracking device of a shipping container truck, according to claim 2, wherein the GPS module is a GPSone positioning system.

5. The tracking device of a shipping container truck, according to claim 2, wherein the GPS module is a CDMA (Code Division Multiple Access) positioning system.

6. The tracking device of a shipping container truck, according to claim 2, wherein the wireless communication transmission module is at least provided with a GSM (Global System for Mobile Communications) transmission unit.

7. The tracking device of a shipping container truck, according to claim 2, wherein the wireless communication transmission module is at least provided with an RF (Radio Frequency) transmission unit.

8. The tracking device of a shipping container truck, according to claim 2, wherein the wireless communication transmission module is at least provided with a CDMA transmission unit.

9. The tracking device of a shipping container truck, according to claim 2, wherein the wireless communication transmission module is at least provided with a GPRS (General Packet Radio Service) transmission unit.

10. The tracking device of a shipping container truck, according to claim 2, wherein the wireless communication transmission module is at least provided with a WiMAX (Worldwide Interoperability for Microwave Access) transmission unit.

11. The tracking device of a shipping container truck, according to claim 2, wherein the wireless communication transmission module is at least provided with an STSC (Satellite to Satellite Communication) transmission unit.

12. The tracking device of a shipping container truck, according to claim 2, wherein the wireless communication transmission module is electrically connected with a control unit.

13. The tracking device of a shipping container truck, according to claim 2, wherein the MCU microprocessor is electrically connected with an ID identification unit.

14. The tracking device of a shipping container truck, according to claim 13, wherein the ID identification unit is electrically connected with a transmission port.

15. The tracking device of a shipping container truck, according to claim 1, wherein the identification chip is electrically connected with a corresponding transmission port.

16. A tracking method of a shipping container truck, comprising:
a step of selecting a shipping container according to a dispatch order, wherein a truck tractor starts for to select the shipping container to be loaded, according to the dispatch order;
a step of accomplishing connecting the truck tractor with the shipping container, wherein the truck tractor is connected with the designated shipping container;
a step of a tracker and an identifier being driven to produce data, wherein after connecting the shipping container truck with the shipping container, the tracker which is assembled in the truck tractor is driven by a power source to operate, accomplishing satellite positioning of the truck tractor, producing driving information related to the truck tractor and inducing to fetch electronic information of the identifier which is assembled in the shipping container;
a step of transmitting the electronic data to a monitoring center, wherein the tracker further transmits the driving information of the truck tractor and the electronic data of the identifier to the monitoring center; and
a step of conducting real time monitoring by the monitoring center, wherein the monitoring center utilizes the received driving information of the shipping container truck and the electronic data of the identifier to effectively monitor the shipping container truck.

17. The tracking method of a shipping container truck, according to claim 16, wherein after accomplishing the step of the tracker and the identifier being driven to produce the data, the tracker fetches the information of the identifier by a wireless transmission method.

18. The tracking method of a shipping container truck, according to claim 16, wherein after accomplishing the step of the tracker and the identifier being driven to produce the data, the tracker fetches the information of the identifier by a wired transmission method.

19. The tracking method of a shipping container truck, according to claim 16, wherein after accomplishing the step of transmitting the electronic data to the monitoring center, the tracker switches manually to transmitting the electronic data by the wireless communication transmission method.

20. The tracking method of a shipping container truck, according to claim 16, wherein after accomplishing the step of transmitting the electronic data to the monitoring center, the tracker switches automatically to transmitting the electronic data by the wireless communication transmission method.
